(19) United States
(12) Patent Application Publication
(10) Pub. No.: US 2017/0122773 A1
(43) Pub. Date: May 4, 2017

(54) Resource Consumption Monitoring System, Platform and Method

(71) Applicant: Global Design Corporation Ltd., Wanchai (HK)

(72) Inventors: Yung Fai Ho, Hong Kong (HK); David Castaneda, Hong Kong (HK)

(21) Appl. No.: 14/928,964

(22) Filed: Oct. 30, 2015

(51) Int. Cl. G01D 4/00

(52) U.S. Cl. CPC G01D 4/002

(57) ABSTRACT

According to one embodiment of the present invention, a monitoring system for monitoring resource consumption of at least one monitored site is disclosed. The system comprises a plurality of sensors deployed at different locations of the at least one monitored site, the sensors being configured to provide measurement values over a data network; a data association facility connected to the data network, the data association facility being configured to associate each measurement value with a location information within the at least one monitored site based on a hierarchical model of the monitored site and type information associated with a corresponding sensor of the plurality of sensors; and a graphical interface facility connected to the data network, the graphical interface facility being configured to selectively display the plurality of measurement values based on the associated location information and type information. According to further embodiments of the present invention, a cloud-based monitoring platform and a monitoring method are provided

### TECHNICAL FIELD

The present invention relates to resource consumption monitoring systems. In particular, the present invention relates to a monitoring system, platform, and method for monitoring resource consumption.

### BACKGROUND

In conventional energy distribution networks, the energy consumption of a site is typically measured at a central supply point, e.g. an electricity meter installed between a supply line of an utility provider and a first distribution panel of a given site, for example a single building or a distinct part of a building such as an apartment or the like. In this way, all electrical energy consumed at that particular site can be measured, irrespective of the electrical distribution system of the given site.

The energy consumption measured at such a central supply point is usually used by the utility provider for billing purposes. Thus, at the end of a billing period such as a month or year, the utility provider usually prepares a utility bill based on the measured total consumption and provides it to the site manager or owner. Based on the provided utility bill, a site manager or owner can then determine whether he or she has stayed within a desirable energy budget or has exceeded it.

Such a conventional approach is sufficient for billing purposes. However, in times of high energy prices and a focus on energy efficiency, the data available in such a conventional scheme is insufficient in order to maintain a control over how the energy is actually consumed within a given site and also in order to estimate, at any given time, whether given energy targets will be met.

In addition to metering devices installed at a central supply point, individual metering devices are known. For example, an individual metering device may be plugged into a socket and supply energy to an individual electricity consumer, such as an electrical appliance. Such energy metering devices allow to measure the energy consumption of a particular appliance at a given location. However, such data is only available locally at the individual metering device. Thus, at least in sites comprising a relatively large number of electrical appliances and other electricity consumers, the use of such metering devices is both expensive and time consuming, if a building manager or owner wants to obtain a reasonably complete picture of the energy consumption of the site to be monitored.

Accordingly, there is a need for better systems and methods for monitoring the energy consumption at a particular site.

Preferably, such improved systems and methods should allow a manager or owner of a site to keep an up-to-date overview of the energy consumption.

### SUMMARY

According to a first aspect of the present invention, a monitoring system for monitoring resource consumption of at least one monitored site is disclosed. The monitored site comprises at least one building. The monitoring system comprises a plurality of sensors deployed at different locations of the at least one monitored site, the sensors being configured to provide measurement values over a data network. The system further comprises a data association facility connected to the data network, the data association facility being configured to associate each measurement value with location information within the at least one monitored site based on a hierarchical model of the monitored site and type information associated with the corresponding sensor of the plurality of sensors. Moreover, the system comprises a graphical interface facility connected to the data network, the graphical interface facility being configured to selectively display the plurality of measurement values based on the associated location information and type information.

According to a second aspect of the present invention, a cloud-based monitoring platform is disclosed. The cloud-based monitoring platform comprises a data capturing module configured to capture granular level, location-specific consumption values provided over at least one data network. The platform further comprises a data association module configured to associate the captured consumption values with location information based on a hierarchical model of at least one monitored site, type information associated with the corresponding source of the captured consumption value and timestamp information based on the time or period, at which the corresponding measurement was obtained. The platform further comprises a data storage module configured to store at least one of the captured consumption values, the hierarchical model of the monitored site, the location information, the type information and the timestamp information associated to the captured consumption values by the data association module. The monitoring platform also comprises graphical interface module configured to selectively display the stored consumption values based on the associated location information and type information.

According to a third aspect of the present invention, a monitoring method is disclosed. The monitoring method comprises obtaining a plurality of granular level, location-specific measurement values from a plurality of sensors deployed at different locations of at least one monitored site. The method further includes associating each measurement value with location information within the at least one monitored site based on a hierarchical model of the monitored site and type information associated with a corresponding sensor of the plurality of sensors, and selectively displaying an interactive representation of the plurality of measurement values based on the associated location information and type information.

The various embodiments of the invention described above enable the implementation of an energy consumption monitoring system, which allows a user to monitor measurement values associated with various parts of a site or various types of sensors using a graphical interface facility. In this way, a plurality of measurement values can be monitored in an easy and intuitive way based on comprehensible information, i.e. location information and type information.

### BRIEF DESCRIPTION OF THE DRAWINGS

Various embodiments of the present invention will be described below with reference to the attached drawings. In the drawings, like reference symbols are used for like elements of different embodiments.

FIG. 1 shows a schematic diagram of a monitoring system in accordance with an embodiment of the invention.

FIG. 2 shows an entity relationship diagram of a data model in accordance with an embodiment of the invention.

FIG. 3 shows a schematic diagram of a hierarchical location model in accordance with an embodiment of the invention.

FIGS. 4A, 4B and 4C show different views of a graphical representation of a monitored building.

FIG. 5 shows a view of a user interface of a monitoring system in accordance with an embodiment of the invention.

FIGS. 6A to 6F show different starburst diagrams in accordance with an embodiment of the invention.

FIGS. 7 and 8 show two different views for representing an energy consumption of a monitored site in accordance with an embodiment of the invention.

### DETAILED DESCRIPTION OF ILLUSTRATIVE EMBODIMENTS

In various embodiments, the present invention relates to a monitoring system for monitoring resource consumption of at least one monitored site that can selectively display a plurality of measurement values of a site to be monitored. Embodiments of the present invention further relates to a cloud-based monitoring platform and an operating method, which can be used to implement such a monitoring system.

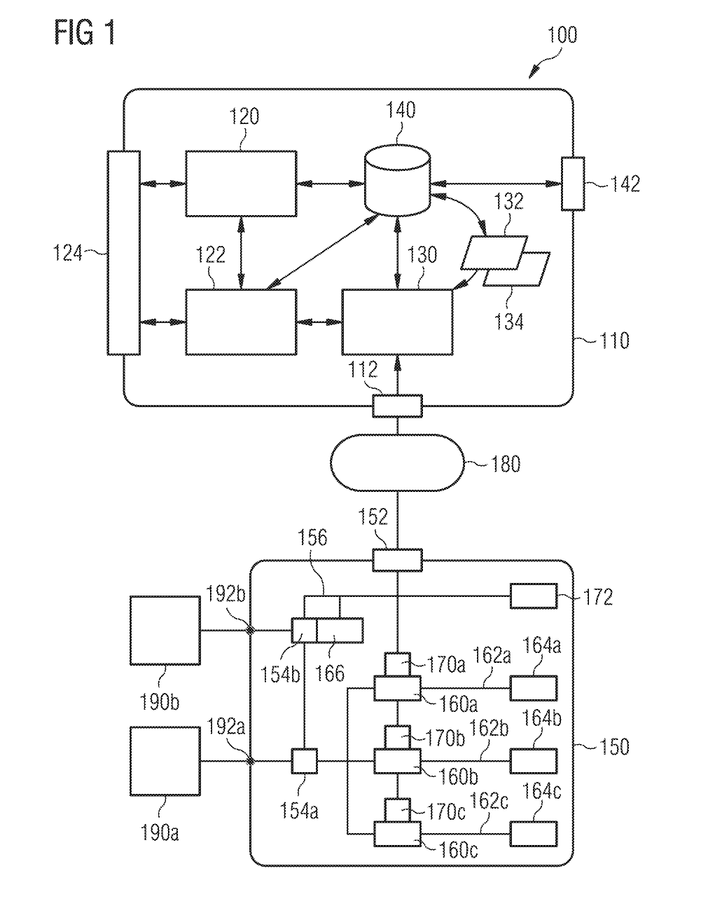

FIG. 1 shows a monitoring system 100 according to an embodiment of the invention. The system 100 comprises a monitoring platform 110 and a measuring system 150 connected thereto via a first gateway 112 and a second gateway 152 of a data network 180 such as the Internet.

The measuring system 150 is deployed at a site to be monitored, for example a single building or a group of buildings. In case multiple buildings are to be monitored, each building may have its own measuring system 150. In the depicted example, the site is supplied with electrical energy by a utility provider 190a at a central electricity supply point 192a. For example, the site may be connected to an energy distribution network of the utility provider 190a by a smart meter device 154a. Moreover, the site is supplied with gas by a second utility provider 190b at a central gas supply point 192b, metered by a gas metering device 154b. However, in an alternative embodiment, energy may be provided by fewer or more providers, through fewer or more supply points and/or by fewer or more energy carriers to the monitored site.

Within the monitored site, the electrical energy supplied by the utility provider 190a is distributed by a number of distribution panels (not shown). Typically, the electrical energy provided to any specific end point within the site to be monitored is provided via at least one distribution panel and protected by at least one circuit-breaker. In the example embodiment shown in FIG. 1, only three circuit-breakers 160a to 160c are shown for reasons of simplicity. However, attention is drawn to the fact that the monitored site may contain tens, hundreds or even thousands of distribution panels and circuit-breakers.

In the described embodiment, each of the circuit-breakers 160a to 160c has a corresponding sensor 170a to 170c assigned to it. The sensors 170 are placed on the circuit-breakers 160 in order to monitor the energy consumption of corresponding circuits 162a to 162c leading to electrical consumers 164a to 164c, respectively. In a different embodiment, the sensors 170 may be associated with individual appliances, groups of circuit-breakers, distribution panels or any other distinct part of the energy distribution network within the site to be monitored. Such sensors and the data they collect are respectively referred to as granular level sensors and granular level energy consumption values in the following.

The measuring system 150 further comprises a heating, ventilation and air conditioning (HVAC) system 166, which is supplied with energy in the form of gas by the gas metering device 154b. Typically, the HVAC system 166 will comprise one or more internal sensors or control devices, which provide information about the energy used by the HVAC system 166 as well as its distribution throughout the monitored site such as a building.

Moreover, the measuring system 150 comprises an additional sensor 172 for obtaining further status information about the monitored site. In the described embodiment, the sensor 172 is a temperature sensor which measures the temperature at one or several location of the monitored site. Data obtained by the sensor 172 may be used to regulate the HVAC system 166 as well as monitoring the current state of the building.

In other embodiments, the measuring system 150 may comprise further sensors, such as sensors for detecting an opened or closed state of windows, doors, or the like.

The HVAC system 166, the sensors 170 and 172 and optionally the metering devices 154a and 154b are connected by a local area network 156. In this way, location-specific energy consumption values for the individual energy consumers 164 and 166 collected at granular level as well as further measurement values such as temperature and door sensor data can be gathered and provided via the gateway 152, the data network 180 and the gateway 112 to the monitoring platform 110.

Attention is drawn to the fact that the present invention is not restricted to the specific measuring system 150 disclosed in FIG. 1. For the purpose of the present invention, it is sufficient to provide relatively fine-grained granular-level measurement values for further analysis as detailed below. Such data may also be obtained by advanced data analysis of data provided by one or a few sensors associated with larger parts of a monitored site, rather than by a large number of sensors associated with individual circuits or energy consuming devices.

The monitoring platform 110 comprises a user interface module 120, a data association module 130 and a data storage facility 140. Moreover, the monitoring platform 110 comprises an aggregation module 122 as well as a user interface 124 and a storage interface 142. These modules may be implemented in hardware or software or a combination thereof. For example, the individual modules may take the form of computer code stored on a non-transitory storage device for execution by a general purpose processing device, such as a processor of a web-server computer.

In operation, the data association module 130 associates measurement values received from the various sensors of the measurement system 150 with location information, type information and timestamp information. For example, the data association module 130 may associate each measurement value with a location corresponding to a part of the monitored site, where the measurement was taken based on a hierarchical building model 132 stored in the data storage facility 140. Furthermore, based on sensor type information 134 also stored in the data storage facility 140, the data association module 130 may record a type of data or a type of an electrical equipment that is associated with the respective sensor.

In addition, the data association module 130 may provide each measurement value with a timestamp comprising a date and time at which the respective measurement was obtained. For example, the date and time at which the measurement value was received over the gateway 112 could be recorded. Alternatively, the timestamp information could already be provided by the respective sensor of the measurement system 150. Rather than a specific point in time, the timestamp information may also relate to a period of time over which the measurement was taken. For example, for a smart meter that measures the average energy consumption over a given period, such as a minute, an hour or a day, corresponding timestamp information of such a period may be recorded.

In the described embodiment, each measurement value is stored in the data storage facility 140 together with the associated location information, type information and timestamp information. In other embodiments, the received measurement values may be stored unaltered. In such a system, the data is queried in combination with further information from the hierarchical location model 132 and data type information 134 stored separately in the storage facility 140 on access.

The user interface module 120 according to the described embodiment generates a variety of different output screens to be displayed over a web interface 124. For example, a user of the monitoring platform 110 may connect to the user interface 124 by means of a web browser over an intranet or the Internet. In the described embodiment, the monitoring platform 110 comprises a user management subsystem (not shown) which restricts the access to the user interface 124 to a set of authorized users. After logging into the monitoring platform 110, the user may select different views of the measurement data and other information stored in the storage facility 140 as explained in more detail below with respect to FIGS. 4A to 8.

In addition to viewing live measurement data of individual sensors 170 and 172, the user interface module 120 may also access the data aggregation module 122 or aggregated data generated by the data aggregation module 122 and stored in the storage facility 140. For example, the data aggregation module 122 may compute aggregated energy consumption values based on a plurality of individual measurement values and the hierarchical location model 132 from information stored in the data storage facility 140. Such data may then be provided to the user interface module 120 for display and further analysis.

The way the data is aggregated, as well as information about the hierarchical location model 132 and the data type information 134 may also be provided by means of the user interface 124. Moreover, information stored in the storage facility 140 may be provided over the storage interface 142 to third party platforms or tools for further analysis.

Lastly, the monitoring platform 110 may comprise an alerting facility allowing the generation of automated alerts based on the monitored measurement values or aggregated measurement values. Further details regarding the alerting facility are disclosed in co-pending patent applications having application Ser. No. ______, Attorney Docket: EBL-010 and application Ser. No. ______, Attorney Docket: EBL-012, which are included by reference herewith.

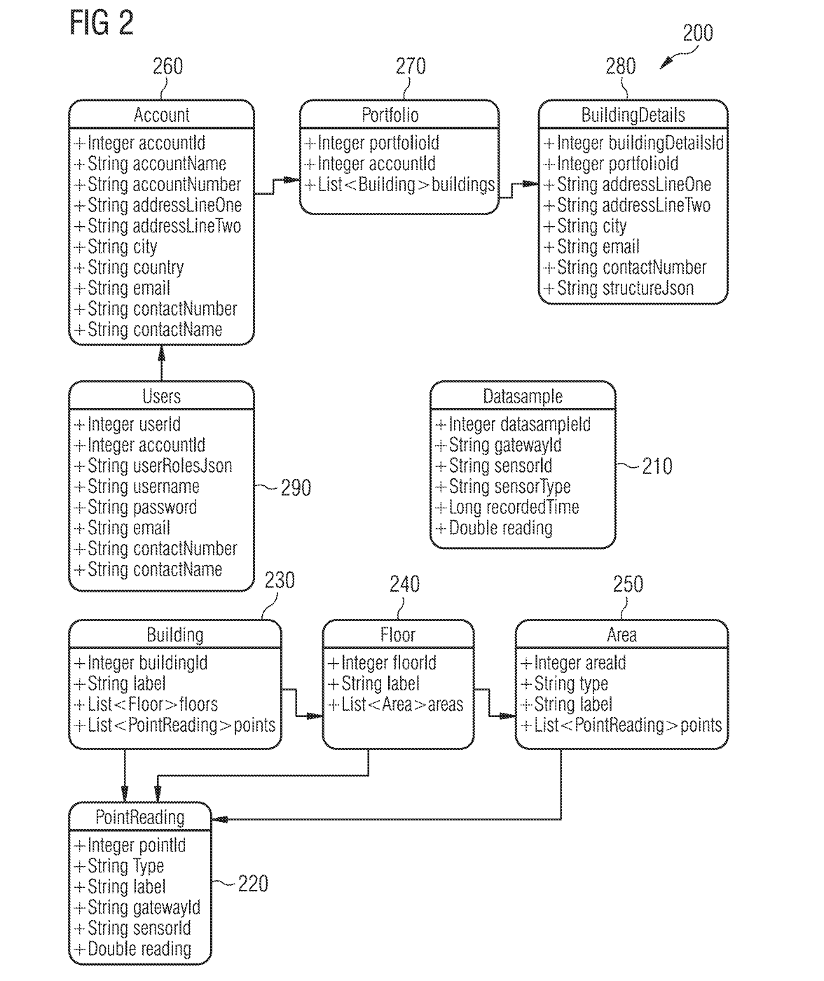

FIG. 2 shows a potential data model 200 for the storage facility 140. In the described embodiment, the data storage facility 140 is implemented as object database management system (ODBMS). As shown in FIG. 2, the data model 200 comprises different types of data objects, which represent various entities of the monitoring platform 110 and measurement system 150.

For example, first type of object 210 represents individual measurement values (Datasample) provided by the sensors 170 and 172 as well as intelligent appliances such as the HVAC system 166. Each Datasample object 210 can be assessed by different attributes, including a sensor identifier, a sensor type and a recording time of the measurement value. Furthermore, each Datasample object 210 comprises reading data corresponding to the measurement value taken.

This information can be transformed into PointReading objects 220 associated with a particular location. In other words, the Datasample object 210 represents raw data and the PointReading object 220 represents the processed data.

In addition to the previous values, a Point Reading object 220 comprises a descriptive label and type information and is associated with a particular part of the monitored site. Information regarding the type of data is stored in the respective type attribute. For example, the type of data may be “True” or “Aggregate”.

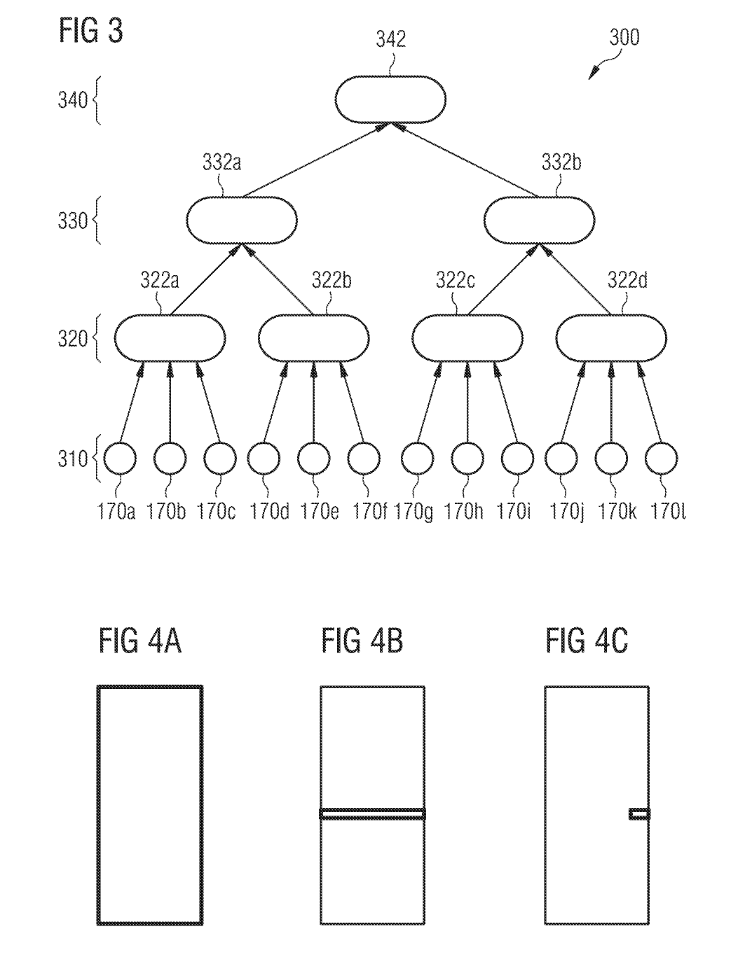

In the embodiment, the parts of the monitored site itself are reflected by corresponding objects stored in the ODBMS, here Building objects 230, Floor objects 240 or Area objects 250, which together form a hierarchical location model as detailed later with respect to FIG. 3. Further metadata regarding each location, such as a suitable label and list of associated other location objects 240 and 240 as well as associated PointReading objects 220 are stored in the respective location objects. Moreover, the objects 250 of the lowest level of the location hierarchy comprises a further attribute regarding the type of the location, such as a room type or equipment type. For example, the type of an area object may be “Room”, “Hallway” or “Lobby”.

Information regarding the type of each measurement is stored in respective type attributes. For example, the type of a measurement value of a Datasample object 210 may be qualified by the type of equipment from which the measurement value originates or the data type corresponding to the data to be observed. For example, a sensor 170 measuring the consumption of electrical energy supplied to a socket may have associated type information specifying the type of the equipment as a socket, i.e. a generic electrical appliance, as well as a unit of the readings, i.e. that it relates to electricity measured in the unit of kilowatt (kW).

In the data model 200 shown in FIG. 2, further data objects such as Account objects 260, Portfolio objects 270, BuildingDetails objects 280 and User objects 290 contain data and metadata used for configuring and operating the monitoring platform 110 as described in other parts of this specification. For details regarding their respective attributes and associations, reference is made to FIG. 2.

FIG. 3 shows an exemplary hierarchy 300 and corresponding data structure of the hierarchical location information, which may be used as part of the configuration data 132 by the data aggregation facility 130. According to the hierarchy 300, a plurality of sensors 170a to 1701 are provided at an end node level 310. For example, one end node level sensor 170 may be provided for every appliance, HVAC outlet or control point, circuit breaker, distribution rail and/or distribution panel of a site to be monitored. According to a second level 320 of a hierarchy 300, groups of sensors 170 are aggregated to form four aggregated data points 322a to 322d at an area level 320. For example, a data point 322 for each room of a site to be monitored could be aggregated at the second level 320. In a third level 330 of the hierarchy 300, individual data points 322 from the second level 320 are aggregated to form two further data points 332a and 332b. For example, aggregated data points 332 corresponding to each floor level of a building could be computed. In a fourth level 340, a single further data point 342 is formed by adding the data point 332a and 332b of the third level 330. In this way, the total energy consumption of a building may be determined.

Attention is drawn to the fact that the hierarchy 300 shown in FIG. 3 is only of exemplary nature and that further levels of the hierarchy may exist above or below the levels 310 to 340. Moreover, not all levels shown in FIG. 3 may be present in particular embodiments of the present invention. Furthermore, other location-specific information may be used in order to aggregate the data obtained at the end node level 310 in order to obtain meaningful aggregate data points according to one or multiple hierarchies.

FIGS. 4A to 8 show different views generated by the user interface module 120 for display by the user interface 124.

FIG. 4A shows an interactive representation of a building to be monitored. In the view according to FIG. 4A, aggregated consumption values of different types of appliances or resources of the monitored site, in particular a lighting system, a HVAC system, electrical energy supplied to individual appliances, a gas consumption, a water consumption and a corresponding amount of carbon dioxide caused by operation of the site is displayed at a building level. By clicking on the building and zooming into a particular floor level, the corresponding consumption values for a selected floor level may be shown as indicated in FIG. 4B. Similarly, an individual room within the floor level may be selected for further analysis (FIG. 4C).

To aid live monitoring and analysis, graphical representations of individual parts of the monitored site, e.g. individual floors or rooms, may be colored based on corresponding consumption values to form a kind of a heat map. For example, a floor having a particular high energy consumption may be colored red, while other floors with a lower energy consumption may be colored green. Similar coloring schemes may be employed to highlight other undesirable states, such as doors and windows permanently left open, or rooms heated to a very high temperature.

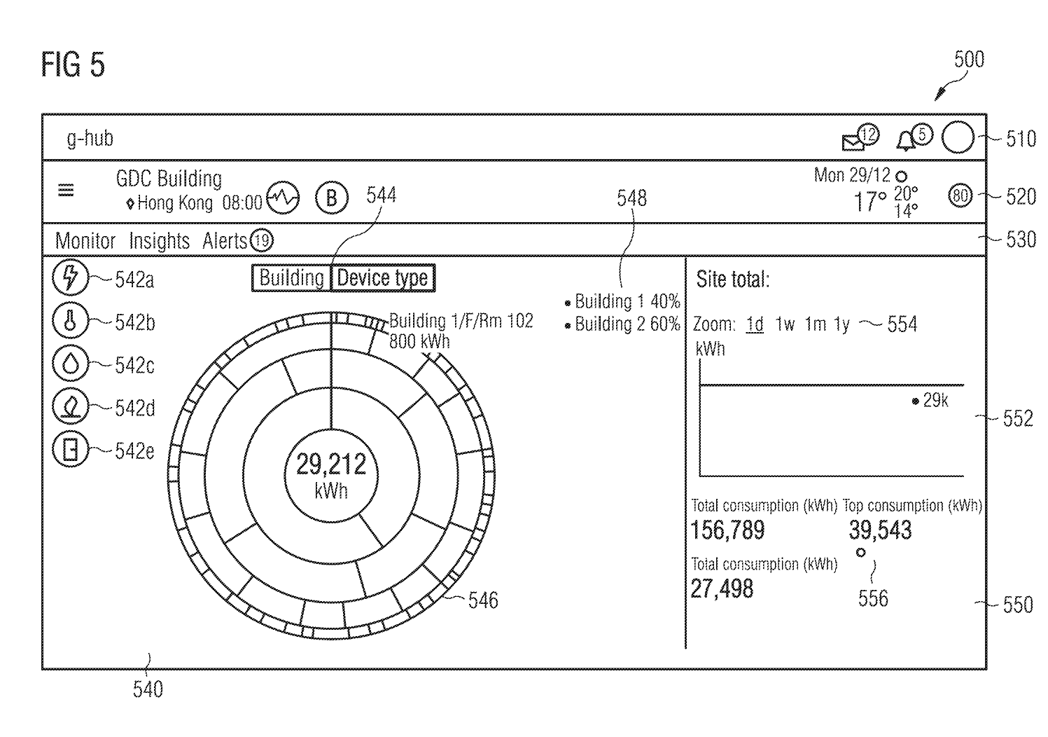

FIG. 5 shows a screen layout of a user interface screen 500 used for a more detailed analysis of the energy consumption of a monitored site. The user interface screen 500 comprises a status area 510 for displaying current alerts as well as unread status messages, and a general information area 520 for displaying information about a selected site. Using a menu bar 530, different display modes of the user interface screen 500 may be selected. In the example shown in FIG. 5, a monitoring mode is selected.

In a main window 540, different types of resources or sensors to be monitored may be selected using buttons 542a to 542e. In the depicted example, the electricity consumption of a selected building is monitored. Using a mode toggle switch 544, the displayed data may be represented based on the hierarchical building model or a device type. In the following explanation, the data is broken down according to the hierarchical location information based, for example, on the hierarchy 300 shown in FIG. 3. The selected consumption data is presented using a so called “sunburst” diagram 546 shown in the middle of the main window 540. Such charts are sometimes also referred to as ring charts or multi-level pie-charts. A legend 548 shows the labels and relative contribution of direct contributors to the selected level of the hierarchy. In the example, the entire site is selected as shown by the inner part of the sunburst diagram 546. Accordingly, the legend 548 shows how the energy consumption is distributed over the buildings belonging to the selected site specified in the general information area 520.

In a sidebar window 550, the development of the monitored data of a selected time period is displayed. For example, the overall energy consumption of the site over the last 24 hour period is shown as graph 552 based on selection criteria 554 and summarized in a summary area 556.

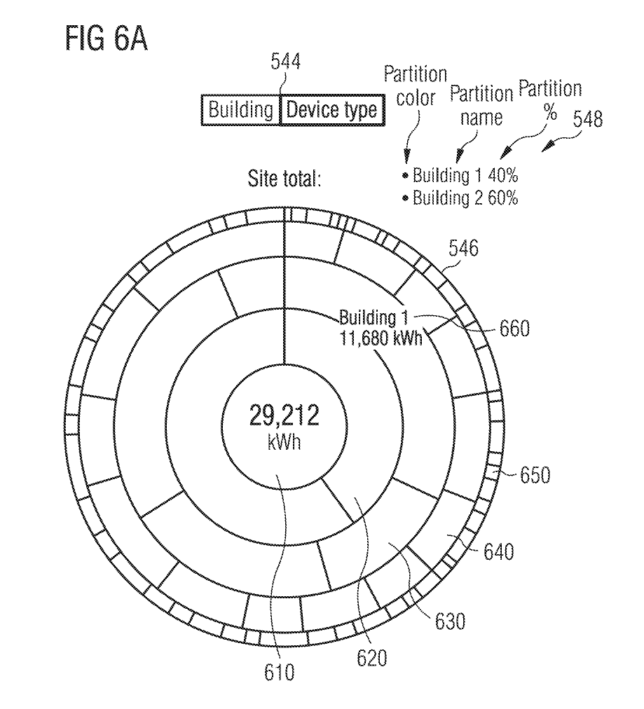

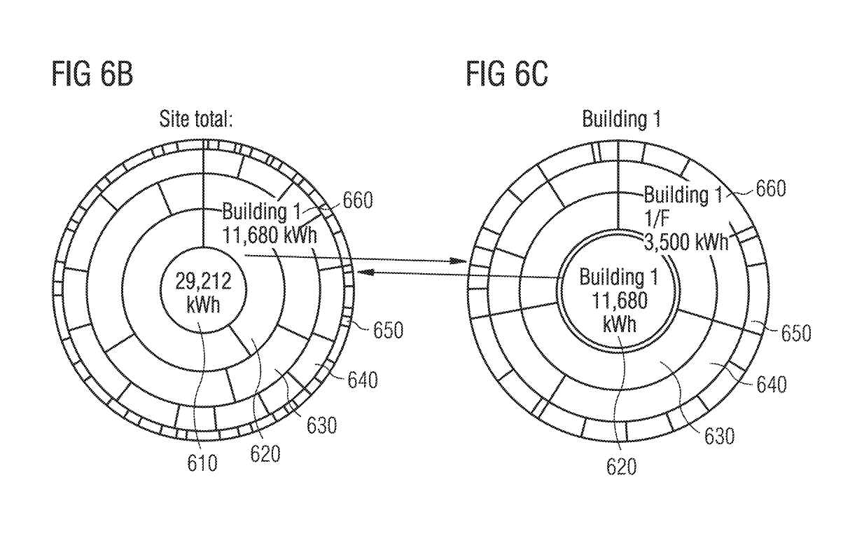

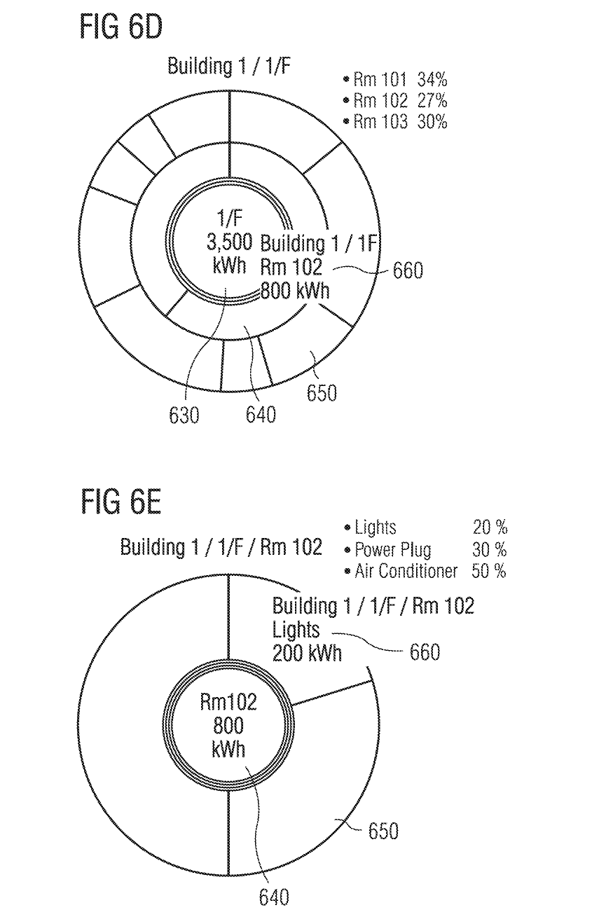

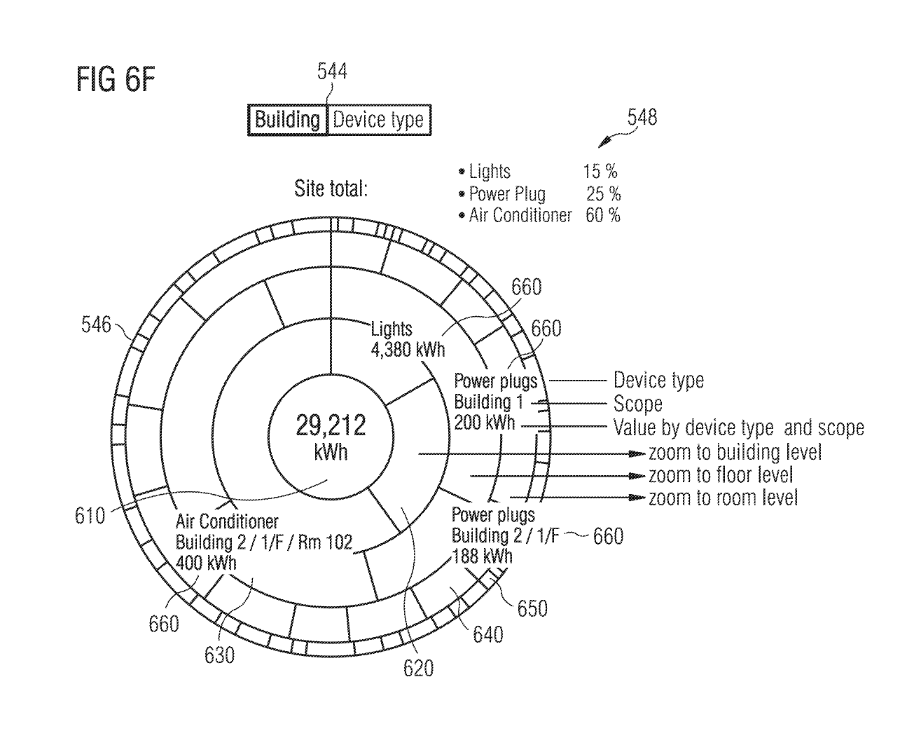

The sunburst chart 546 of the interface screen 500 allows a user to drill down into the consumption of a selected resource by clicking on the respective area of the sunburst chart 546. This process is explained in more detail with respect to FIGS. 6A to 6E.

Firstly, FIG. 6A shows the semantics associated with the various areas of the sunburst chart 546. In the given example, the innermost ring 610 represents an electrical energy reading for the entire site. The next ring 620 corresponds to a building level and shows that the first building consumes 40 percent of the electrical energy and the second building consumes 60 percent of the electrical energy provided to the site. The next ring 630 shows how the energy is distributed to different floor levels of the monitored building. On the next ring 640, this energy is further allocated to individual rooms of a corresponding floor. On the outermost ring 650 the electrical energy consumption as monitored by corresponding sensors is indicated. In particular, each lower level entity should be associated with one higher level entity. When placing a mouse pointer over one of the segments of the sunburst chart 546, a corresponding information box 660 is displayed, showing the associated label and consumption value.

In contrast to conventional solutions, where only a total energy consumption of a building or site is measured and then broken down based on statistical models to individual parts of the building, the mechanism behind the monitoring platform 110 uses a different approach. In particular, as explained above, granular level consumption values of individual sensors correspond to the outermost ring 650 data segments. Based on this granular level consumption data, higher levels of the hierarchy, such as a room, floor and building level, are computed by adding up the data of respective lower level values. In this way, a more precise allocation of energy consumption to individual parts of a building can be established.

FIGS. 6B to 6E show the reaction of the user interface screen 500 to a click of the user on respective parts of the sunburst diagram 546. For example, when selecting the segment of the second ring corresponding to the first building as shown in FIG. 6B, the sunburst chart 546 will only display energy consumption related to the first building. Accordingly, a new sunburst chart is generated as shown in FIG. 6C. Similarly, by selecting a specific floor or room, the user may further drill down into the data available as shown in FIGS. 6D and 6E. In view shown in FIG. 6E, only the energy consumption of a single room, room 102, is shown. Based on the sensor type information stored in the data storage facility 140, the energy consumption of a single room may be further broken down into the energy consume by lights, the power plugs and an air conditioning system.

A similar analysis may be performed starting with the device type by clicking on the mode toggle switch 544 as shown in FIG. 6F. Accordingly, the sunburst chart 546 changes to represent the energy consumption for different types of consumers in the ring surrounding the center of the sunburst chart. Then, in the subsequent outer rings, the type-specific energy consumption may be broken down according to the hierarchical location information associated with the aggregated measurement values as described above.

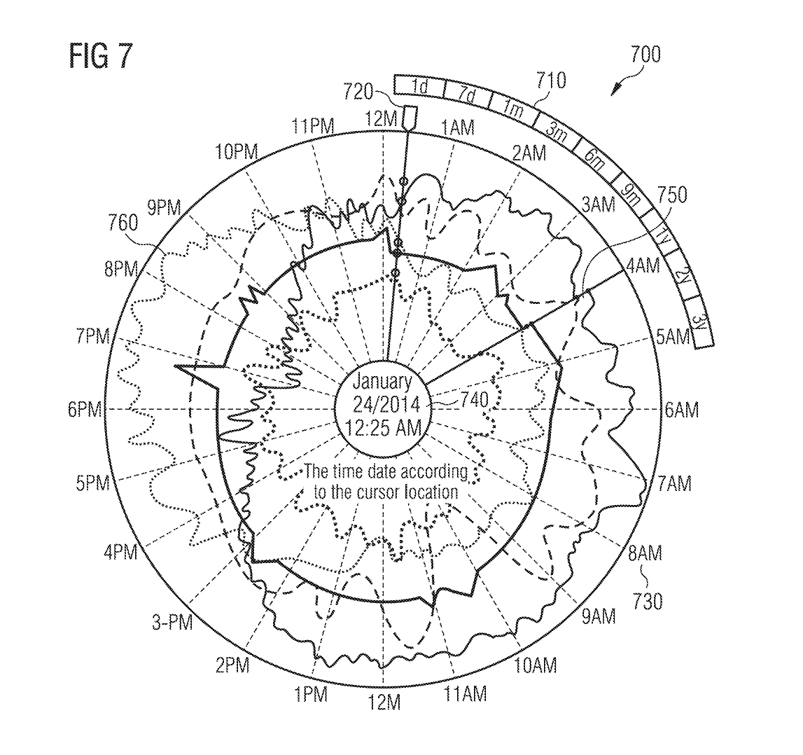

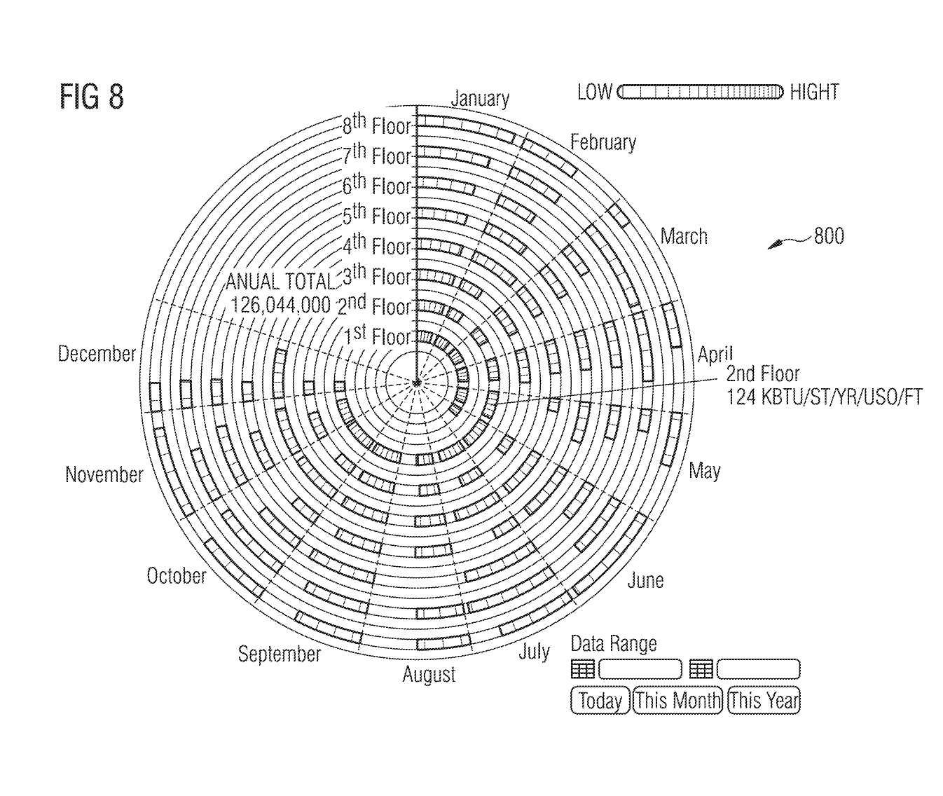

FIGS. 7 and 8 show two further views of the energy consumption of a building, in particular in a live monitoring mode. In particular, FIGS. 7 and 8 show the live monitoring mode for data with the point type “True”. For example, in case of the consumption data is collected from the central meter device 154a, the live data is shown in general including any aggregation that is conducted.

FIG. 7 shows a circadian chart 700 of the energy consumption collected over the course of a day based on the stored timestamp information. By means of the chart shown in FIG. 7, particular peak loads and usage patterns may be identified in order to optimize the energy consumption of a building.

As shown in FIG. 7, user may select a period to be analyzed based on option buttons 710. For example, he or she may analyze the last day, the last week, the last month, the last quarter, the last year and so on. Within the selected time period, he may analyze one particular point of time in more detail by use of a cursor 720. If the user does not touch the cursor 720, the cursor will automatically go to the time corresponding to the current time. However, the user may also drag the cursor 720 to any desired position. Labels 730 indicate the period range selected based on the selection button 710. The time and date selected by the cursor position of the cursor 720 is also displayed in a central box 740.

The background color of the diagram is shaded according to the freshness of the data. In particular, the shaded area 750 represents past data. Once new data becomes available for a given time period, this is indicated by a brighter background color. If the user moves the mouse pointer to one of the graph lines 760 corresponding to a measuring attribute such as energy data, the circadian chart 700 itself would only show the energy data, hiding all other measuring attributes.

FIG. 8 shows a chart 800 of the energy consumption aggregated over a monthly period for a year. Based on the view shown in FIG. 8, seasonal effects on the energy consumption of a site may be analyzed in more detail.

As described before, the individual areas of the charts according to FIGS. 7 and 8 may be colored to highlight particular high energy consumption values within the analyzed time period. Moreover, by selecting individual segments of the diagram, a user may drill down to analyze the corresponding data in more detail.

According to the present invention, the user can obtain a live picture of consumption data for different levels of granularity using data aggregation. For example, the monitoring platform 110 can calculate the total floor consumption by summing up all the energy consumption values collected at the equipment level of each room of a site to be monitored.

As a use case, the energy monitoring system 100 allows a user to compare an estimated energy saving associated with a building upgrade, for example changing an existing lighting system to a more energy efficient lighting system, with the actual energy consumption of the building after the change. In this way, the efficiency of different measures improving overall energy efficiency may be assessed objectively in order to maximize a return on investment with respect to climate change mitigation technology.

Based on the used, flexible location model, such an assessment task can be performed at various levels of granularity. For example, a site administrator may compare the energy consumption of one floor already upgraded with a new lighting system with another floor, whose lighting system has not been upgraded yet. Moreover, a building owner may compare different buildings of his or her property portfolio in order to compare the efficiency of individual building managers and users.

What is claimed is:

1. A monitoring system comprising:
a plurality of sensors deployed at different locations of at least one monitored site comprising at least one building, the sensors being configured to provide measurement values over a data network;
a data association facility connected to the data network, the data association facility being configured to associate each measurement value with location information within the at least one monitored site based on a hierarchical model of the monitored site and type information associated with a corresponding sensor of the plurality of sensors; and
a graphical interface facility connected to the data network, the graphical interface facility being configured to selectively display the measurement values based on the associated location information and type information.

2. The monitoring system according to claim 1, further comprising:
a data storage facility connected to the data network, the data storage facility being configured to store at least one of the measurement values provided by the plurality of sensors, the hierarchical model of the monitored site, the location information and the type information associated to the measurement values by the data association facility.

3. The monitoring system according to claim 1, wherein the data association facility is further configured to associate each measurement value with timestamp information based on a time or a time period at which the corresponding measurement was obtained.

4. The monitoring system according to claim 1, wherein the graphical interface facility is configured to display a graphical representation of the monitored site overlaid with measurement values based on the location information determined based on the hierarchical model of the monitored site.

5. The monitoring system according to claim 4, wherein the graphical interface facility is configured to present the most recent measurement values of each sensor in a heat map overlaid with the graphical representation of the monitored site.

6. The monitoring system according to claim 1, further comprising:
a data aggregation facility connected to the data network, the data aggregation facility being configured to sum up measurement values according to at least one of the location information, type information and timestamp information associated to corresponding measurement values by the data association facility.

7. The monitoring system according to claim 6, wherein the hierarchical model of the monitored site comprises at least one of room level, a floor level, an apartment level, a building level and a site level; and the data aggregation facility is configured to sum up measurement values for a given room, floor, apartment, building or site.

8. The monitoring system according to claim 7, wherein the plurality of sensors are configured to measure at least one of an electrical energy consumption, a gas consumption, an oil consumption and a water consumption; the type information comprises data type information; and the data aggregation facility is configured to sum up measurement values based on the data type information for a given room, floor, apartment, building or site.

9. The monitoring system according to claim 7, wherein the plurality of sensors are configured to measure an energy consumption of at least one of a heating system, a ventilation system, an air conditioning system, a lighting system and a cooking appliance; the type information comprises equipment type information; and the data aggregation facility is configured to sum up measurement values based on equipment type information for a given room, floor, apartment, building or site.

10. The monitoring system according to claim 7, wherein the type information comprises room type information; and the data aggregation facility is configured to sum up measurement values based on room type information for a given room, floor, apartment, building or site.

11. The monitoring system according to claim 6, wherein the graphical interface facility is configured to display an interactive chart of aggregated measurement values according to at least one of the location information and type information associated with the measurement values by the data association facility.

12. The monitoring system according to claim 11, wherein the least one graphical interface facility is configured to enable a user to drill down into a selected aggregated measurement value based on at least one of the hierarchical model of the location information and a data type, an equipment type or a room type comprised in the type information by selecting a particular location or type of measurement value in the interactive chart.

13. The monitoring system according to claim 11, wherein the graphical interface facility is configured to display a sunburst chart based on at least one of the location information and type information associated with the measurement values by the data association facility.

14. The monitoring system according to claim 13, wherein the sunburst chart comprises different rings and each ring of the sunburst charts represents a different level of the hierarchy of the hierarchical model of the monitored site.

15. The monitoring system according to claim 13, wherein an outermost ring of the sunburst chart visualizes measurement values provided by the plurality of sensors and at least one inner ring visualizes aggregated measurement values provided by the data aggregation facility.

16. A cloud based monitoring platform comprising:
an data capturing module comprising a plurality of sensors, wherein the data capturing module is configured to capture granular level, location-specific consumption values provided over at least one data network;
a data association module comprising instructions to be executed on a processor, the instructions configured to associate the captured consumption values with location information based on a hierarchical model of at least one monitored site, type information associated with a corresponding source of the captured consumption value and timestamp information based on the time or time period at which the corresponding measurement was obtained;
a data storage module comprising a non-transitory storage medium and configured to store at least one of the captured consumption values, the hierarchical model of the monitored site, the location information, the type information and the timestamp information associated to the captured consumption values by the data association module; and
a graphical interface module configured to selectively display the at least one of the consumption values stored in the data storage module based on the associated location information and type information.

17. The cloud based monitoring platform according to claim 16, further comprising
a data aggregation module comprising instructions to be executed on the processor, the instructions configured to sum up consumption values according to at least one of the location information, type information and timestamp information associated to corresponding consumption values by the data association module or stored in the data storage module.

18. A monitoring method comprising:
obtaining a plurality of granular level, location-specific measurement values from a plurality of sensors deployed at different locations of at least one monitored site;
associating each measurement value with location information within the at least one monitored site based on a hierarchical model of the monitored site and type information associated with a corresponding sensor of the plurality of sensors; and
selectively displaying an interactive representation of the plurality of measurement values based on the associated location information and type information.

19. The monitoring method according to claim 18, further comprising:
aggregating a plurality of individual measurement values according to at least one of the associated location information and type information into a plurality of aggregated measurement values; and
selectively displaying an interactive representation of the plurality of aggregated measurement values.

20. The monitoring method according to claim 19, wherein in the steps of selectively displaying, a sunburst chart based on at least one of the associated location information and type information is displayed, wherein an outermost ring of the sunburst chart visualizes the obtained measurement values and at least one inner ring visualizes the aggregated measurement values.
